(19) United States
(12) Patent Application Publication
(10) Pub. No.: US 2025/0300416 A1
(43) Pub. Date: Sep. 25, 2025

(54) Device For Fixing An Optical Element

(71) Applicant: II-VI Delaware, Inc., Wilmington, DE (US)

(72) Inventor: Daniel Labahn, Wilmington, DE (US)

(21) Appl. No.: 18/662,125

(22) Filed: May 13, 2024

(30) Foreign Application Priority Data
Mar. 19, 2024 (DE) 10 2024 107 748.4

(51) Int. Cl. H01S 3/00; H01S 3/034

(52) U.S. Cl. CPC H01S 3/005; H01S 3/034

(57) ABSTRACT

The present disclosure relates to a system for inserting a lens tube into an optical system, comprising an optical system housing having an opening for inserting a lens tube transverse to the beam direction of the optical system into a space behind the opening, with the space having lateral guiding and positioning elements; and the lens tube having sliding and sealing elements at its end face.

### CROSS-REFERENCE TO RELATED APPLICATIONS

The present application claims priority of German patent application DE 10 2024 107 748.4 filed on Mar. 19, 2024. The aforementioned application is hereby incorporated herein by reference in its entirety.

### FIELD OF THE DISCLOSURE

The present disclosure relates generally to a system with a mounting structure for an optics bus in a laser processing system for simplified installation and removal.

### BACKGROUND OF THE DISCLOSURE

Lasers, laser processing heads and systems, components and accessories for them, as well as laser measuring instruments, are known in the art. The laser processing heads and systems are designed for processing materials, including welding, soldering and cutting.

Laser processing heads and systems comprise a large number of optical elements. For example, lenses that collimate or focus the laser beam are used in laser processing systems to shape the beam. In laser material processing of metals or other materials, it is often desirable to shape the beam so that it has the appropriate properties for the respective application. Such beam shaping is achieved by means of optical elements which are arranged in the beam direction of the laser beam.

The optical elements can be arranged in a so-called lens tube. In one example embodiment, the lens tube is a cylinder, in the interior of which the optical elements are arranged, although other embodiments are contemplated by this disclosure. The optical elements may be lenses, lens groups, mirrors, beam-shaping optical elements, including refractive and diffractive optical elements, and/or protective glasses. The advantage of using a lens tube is that the optical elements can be replaced as a unit. If individual optical elements are replaced, it may be necessary to reposition the respective optical elements correctly in relation to each other. This effort is not required when using a lens tube.

Lens tubes are known from the state of the art, which are installed in optical devices with the aid of screw rings, clamps or similar. Assembly and disassembly is usually only possible with screw-in tools or other special tools. To replace the lens tubes, the device in which the lens tube is used must sometimes be dismantled. In order to prevent contamination, the replacement of an optical element must be carried out in a dust-free room to avoid contamination of the device with particles, for example. This will significantly extend the downtime of a device for replacing a lens tube.

This is usually a disadvantage when replacing optical elements at the end customer or when servicing. Screw connections in the optical compartment are also considered disadvantageous due to material abrasion, as deposits can be carried into the optical compartment.

Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

The present disclosure relates generally to a system with a mounting structure for an optics bus in a laser processing system for simplified installation and removal, and which overcomes disadvantages found in the prior art.

These and other advantages, aspects and novel features of the present disclosure, as well as details of an illustrated embodiment thereof, will be more fully understood from the following description and drawings.

### BRIEF DESCRIPTION OF THE DRAWINGS

The disclosure is illustrated in more detail below with reference to drawings. It is obvious to the person skilled in the art that these are only possible, exemplary embodiments, without the disclosure necessarily being limited to the embodiments shown, wherein:

FIG. 1 schematically shows a housing with an opening in front of which a lens tube is arranged, in accordance with an example embodiment of the disclosure.

FIG. 2 schematically shows the interaction of the sliding and/or sealing elements with the guide elements when the lens tube is inserted into the housing, in accordance with an example embodiment of the disclosure.

FIG. 3 shows the lens tube in its final position in the housing of the optical device, in accordance with an example embodiment of the disclosure.

FIG. 4 shows the lens tube in its final position inside the housing of the optical device with the cover closed, in accordance with an example embodiment of the disclosure.

FIG. 5 shows first and second additional positioning elements of the housing and the cover for defined positioning of the lens tube, in accordance with an example embodiment of the disclosure.

FIG. 6 schematically shows a section through space at 90° to the previous figures, in accordance with an example embodiment of the disclosure.

### DETAILED DESCRIPTION OF THE INVENTION

Other aspects, features and advantages of the present disclosure will readily be apparent from the following detailed description, which simply illustrates preferred embodiments and implementations. The present disclosure may also be realized in other and different embodiments and its various details may be modified in various obvious aspects without departing from the teachings and scope of the present disclosure. Accordingly, the drawings and descriptions are illustrative and not limiting. Additional features and advantages of the disclosure are set forth in part in the following description and will be apparent in part from the description or may be inferred from the embodiments of the disclosure.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

One purpose of the present disclosure is to provide an alternative attachment for a lens tube which avoids the disadvantages of solutions known from the prior art.

The previously formulated task of the disclosure is solved by the features of the independent claims. The dependent claims cover further specific embodiments of the disclosure.

According to an example embodiment of the disclosure, a system comprising a receptacle for a lens tube and a lens tube is provided, in which the receptacle for the lens tube is formed by a lateral opening in the housing of the optical device. Inside the optical device, spacers and/or guides are provided in the area of the receptacle, which ensure exact positioning of the lens tube in the receptacle.

A lens tube in the sense of an example embodiment of the present invention is to be understood as a cylindrical arrangement which has an arrangement of optical elements in its interior. The lens tube is sealed in order to prevent the entry of concentrations or contaminates into the lens tube. In addition, the optical elements are fixed in their alignment inside the lens tube.

The lens tube is designed as a slide-in element and is installed in the optical device via the receptacle, which is designed as a lateral opening in the housing. Sliding and/or sealing elements can be attached to the end faces of the lens tube and/or to the guides and/or spacers of the housing to facilitate the insertion of the lens tube, minimize abrasion and seal off the space around the optical axis of the device in a dust-tight manner.

The lens tube holder is closed with a cover. Suitable contours (wedges, half shells, stops, balls and the like) are arranged in the housing and cover to ensure exact alignment of the lens tube. Furthermore, sealing elements are provided, or the contours are designed in such a way that they ensure adequate sealing of the opening against the ingress of contaminants such as dust or particles.

The lens barrel itself can contain all kinds of optical elements, such as lenses, protective glasses, mirrors, beam shaping elements or similar.

The housing of the optical device and the lid or cover of the mount ensure exact alignment of the lens tube using the aforementioned contours (wedges, half shells, stops, balls and the like). By screwing the cover to the device, the lens tube is clamped firmly in place to prevent the entry of particles and dirt.

The lens tube has sliding and sealing elements which, on the one hand, enable the lens tube to be pushed in, but also prevent abrasion and contamination during insertion and removal. On the other hand, these elements ensure that the lens tube is held securely inside the optical device. Furthermore, these elements seal the lens tube against the volume inside the optical device.

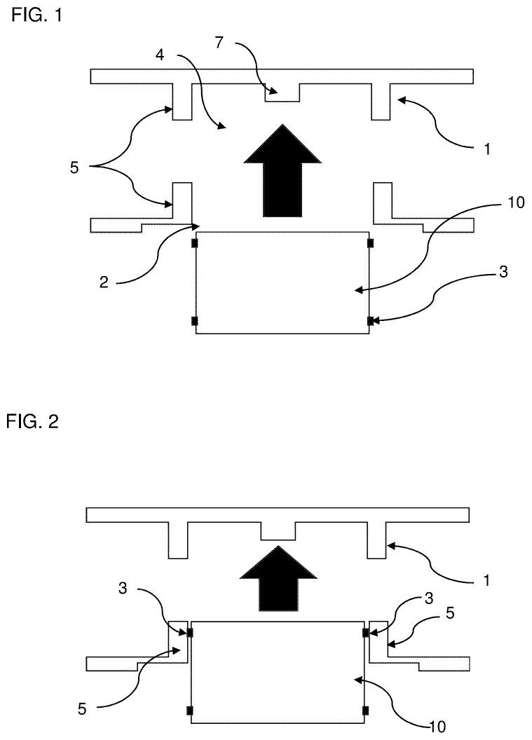

FIG. 1 schematically shows a housing 1 with an opening 2, in accordance with an example embodiment of the disclosure. A lens tube 10 is arranged in front of the opening 2. The housing has lateral guiding and positioning elements 5 so that the lens tube 10 can only be inserted into the housing 1 of the optical device in a previously defined position. A first stop 7 is arranged at the end of the space 4 for inserting the lens tube 10, which limits the maximum insertion of the lens tube 10 into space 4 and also ensures the desired alignment of the lens tube. The lens tube is inserted in the direction shown by the arrow.

FIG. 2 schematically shows the interaction of the sliding and/or sealing elements 3 with the guide elements 5 when the lens tube 10 is inserted into the housing 1, in accordance with an example embodiment of the disclosure. The arrow again indicates the direction of insertion.

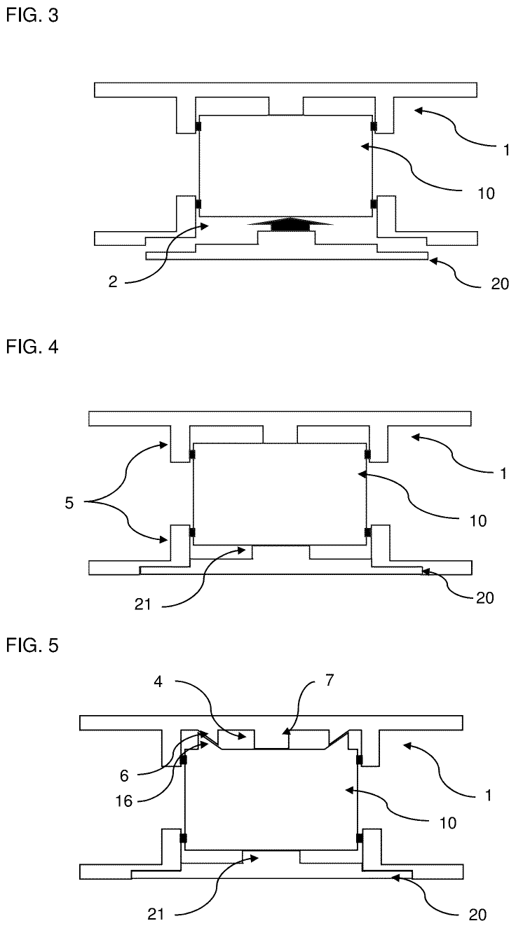

FIG. 3 shows the lens tube 10 in its final position in the housing 1 of the optical device, in accordance with an example embodiment of the disclosure. The cover 20 of the housing 1 has not yet been applied to the opening 2 through which the lens tube 10 was inserted into the housing 1 of the optical device.

FIG. 4 shows the lens tube 10 in its final position inside the housing 1 of the optical device with the cover 20 closed, in accordance with an example embodiment of the disclosure. The cover 20 has a second stop 21 for securely and firmly holding the lens tube 10 inside the housing 1 of the optical device. The lens tube 10 is firmly arranged between the first stop 7, the second stop 21 and the lateral guiding and positioning elements 5.

FIG. 5 shows first and second additional positioning elements 6, 16 of the housing 1 and the cover for the defined positioning of the lens tube 10, in accordance with an example embodiment of the disclosure. The first additional positioning elements 6 of the housing have an angle which corresponds to the angle of the second additional positioning elements 16, which are arranged on the lens tube 10. The lens tube 10 is centered in the space 4 by the corresponding angles of the first and second additional positioning elements 6, 16. Cover 20 with second stop 21 exerts pressure on the lens tube 10 so that it is centered on the beveled surfaces of the first and second positioning elements 6, 16 in front of the first stop 7. An inclination of the first and second stop adds up to 90°.

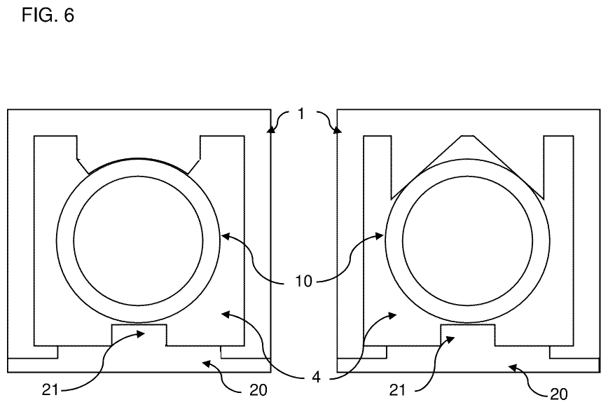

FIG. 6 shows a schematic section through space 4 at 90° to the previous figures, in accordance with an example embodiment of the disclosure. The lens tube 10 is already arranged in the housing 1. Cover 20 with second stop 21 exerts pressure on the lens tube 10 so that it is centered on the beveled surfaces of the first and second positioning elements 6, 16 in front of the first stop 7.

The second stop 21 can be concave in such a way that the curvature corresponds to the outer shape of the lens tube. Furthermore, the second stop can be formed from two beveled elements.

As set forth above, the present disclosure provides a system for inserting a lens tube into an optical system comprising:
a housing of an optical system with an opening for inserting a lens tube transverse to the beam direction of the optical system into a space behind the opening, the space having lateral guiding and positioning elements; and
the lens tube, which has sliding and sealing elements on its end faces.

In one embodiment of the system according to the present disclosure, the space behind the opening has a first stop on the wall of the housing opposite the opening.

Furthermore, according to the present disclosure, the system has a cover for closing the opening, with the cover having a second stop, depending on the embodiment, in order to fix and align the lens tube between the first and second stop after insertion.

According to an embodiment of the present disclosure, the first stop of a system in one embodiment has a concave shape corresponding to the outer shape of the lens tube.

According to an embodiment of the present disclosure, the system also includes a first stop, which is made up of two triangular elements.

According to an embodiment of the present disclosure, the system has first additional positioning elements on the side of the housing of the optical system opposite the opening.

Furthermore, in one embodiment, the lens tube has second additional positioning elements on the longitudinal side facing the side of the housing of the optical system opposite the opening.

In one embodiment, the first and second additional positioning elements are beveled in such a way that the angles of the respective bevels add up to 90°.

The present disclosure further comprises an example embodiment of the system in which one or more optical elements, for example from the group comprising lenses, lens groups, mirrors, beam shaping optical elements, refractive and diffractive optical elements, and protective glasses, are arranged in the lens barrel.

Furthermore, the cover and opening of a system according to the present disclosure may have corresponding shapes for correct alignment of the lens tube. The corresponding shapes may comprise one or more of wedges, half shells, stops and balls.

As more fully described above, the present disclosure provides an alternative for inserting and fixing a lens tube in an optical device. The lens tube is firmly arranged and fixed in a previously defined position in the housing of the optical device. In addition, the lens tube is sealed dust-tight against the opening through which it is inserted.

Example advantages of the present disclosure can be summarized as follows:
Simple insertion of a lens tube into a housing.
Secure positioning of the lens tube in the housing using positioning elements.
Lens tube can be replaced without special tools.
Reduction of the entry of contaminants.
Lens tube can be replaced in the field.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. For example, the disclosed magnetometers may include additional components such as a reference magnet, electrical driver, power monitors, etc. without departing from the scope of the present disclosure. Therefore, it is intended that the present disclosure not be limited to the examples disclosed, but that the disclosure will include all examples falling within the scope of the appended claims.

What is claimed is:

1. A system for inserting a lens tube into an optical system, comprising
an optical system housing having an opening for inserting a lens tube transverse to the beam direction of the optical system into a space behind the opening, the space having lateral guiding and positioning elements; and
the lens tube, having sliding and sealing elements on its end faces.

2. The system according to claim 1, wherein the space behind the opening has a first stop on the wall of the housing opposite the opening.

3. The system according to claim 1, comprising a cover for closing the opening.

4. The system according to claim 3, wherein the cover has a second stop for fixing and aligning the lens tube after insertion between the first and second stops.

5. The system according to claim 1, wherein the first stop has a concave shape corresponding to the outer shape of the lens tube.

6. The system according to claim 1, wherein the first stop is formed from two triangular elements.

7. The system according to claim 1, wherein the side of the housing of the optical system opposite to the opening comprises first additional positioning elements.

8. The system according to claim 7, wherein the lens tube has second additional positioning elements on the longitudinal side facing the side of the housing of the optical system opposite the opening.

9. The system according to claim 7, wherein first and second additional positioning elements are beveled such that the angles of the respective bevels add up to 90°.

10. The system according to claim 1, wherein optical elements selected from the group comprising lenses, lens groups, mirrors, beam shaping optical elements, refractive and diffractive optical elements, and protective glasses are arranged in the lens barrel.

11. The system according to claim 3, wherein the cover and opening have corresponding shapes for correct alignment of the lens tube.

12. The system according to claim 11, wherein the corresponding formations are selected from the group comprising wedges, half shells, stops and balls.
